(19) United States
(12) Patent Application Publication
(10) Pub. No.: US 2026/0278636 A1
(43) Pub. Date: Sep. 17, 2026

(54) SYSTEMS AND METHODS FOR REAL TIME REWARD REDEMPTION AT POINT OF SALE

(71) Applicant: The PNC Financial Services Group, Inc., Pittsburgh, PA (US)

(72) Inventors: Rajesh Raman, Sewickley, PA (US); Ashley Renee Hall, Abington, PA (US); Meghan Schiffer, Pittsburgh, PA (US)

(73) Assignee: The PNC Financial Services Group, Inc., Pittsburgh, PA (US)

(21) Appl. No.: 19/672,856

(22) Filed: May 11, 2026

Related U.S. Application Data
(63) Continuation of application No. 18/891,081, filed on Sep. 20, 2024.
(60) Provisional application No. 63/575,257, filed on Apr. 5, 2024.

(51) Int. Cl. G06Q 30/0238; G06Q 20/20

(52) U.S. Cl. CPC G06Q 30/0238; G06Q 20/208

(57) ABSTRACT

The disclosed embodiments describe systems and methods for a process for providing a discount for at least one product in real-time. The process may comprise at least one server comprising memory and at least one processor configured to receive product information from a user device through a discount application. The user device may be configured to identify the product information for at least one product before a vendor transaction at a vendor is completed. The at least one processor may be configured to access at least one database containing user information, vendor information, and discount information. The discount information may be provided to the user device through the discount application to provide at least one discount to the at least one product in real-time before the vendor transaction is completed.

### CROSS-REFERENCE TO RELATED APPLICATIONS

The present application claims the benefit of priority of U.S. Provisional Application No. 63/575,257, filed Apr. 5, 2024, the entire contents of which are incorporated herein.

### TECHNICAL FIELD

The present disclosure relates generally to systems and methods for improving the efficiency and access of transaction discounts at point of sale in real time. More specifically, the present disclosure relates to searching databases for active discounts, including eligible coupons, that can be applied at the time of purchase with ease for a shopper.

### BACKGROUND

When shopping online or in person, it can be overwhelming to find a good deal on a product. After a purchase, a shopper may be left wondering if they had purchased a product at a higher cost than they otherwise could have. For example, many discounts (e.g. coupons) are incorrect, have expired, or simply will not work. While these problems can be daunting with online shopping, they are made significantly more complex while performing in-person shopping.

In person, a shopper may need to search, identify, and determine ahead of time which coupons to bring to a store, or which discounts may currently be active. A shopper may fear missing discounts that may have been available but that they were not aware of. Presently, systems and methods that provide discounts may require manual input and custom searching from a shopper for relevant products while shopping in-person. Such an approach is time-consuming and prone to user error. For example, discounts may be missed or misidentified for a relevant product. Another problem is that while shopping, a user may find products that the user wishes to purchase but did not originally plan on purchasing, and in such a situation the user may not be able to obtain relevant discounts for those products. Additionally, access to in-person coupons or discounts often requires downloading specific smartphone applications, which may quickly become cumbersome if a shopper shops at many merchants. Even with the use of email or text notifications, it can be difficult to organize and apply these coupons and discounts and be sure that they are applicable (e.g. not expired or exclusive due to another discount). Additionally, a shopper may have lost a coupon or forgotten to bring their coupon. To reduce the occurrence of these problems, there is a need to improve the implementation and use of discounts while shopping.

The systems and methods described herein may demonstrate a way to rapidly identify, in real-time, any discounts (e.g. coupons and other rewards) that may be redeemed to reduce the cost of a product while shopping or at a point of sale, thereby saving a customer time and money. These systems and methods may be used in a variety of different shops. For example, the systems and methods may be used in retail shops, grocery stores, restaurants, malls, and entertainment venues (e.g. theaters, theme parks, etc.).

### SUMMARY

The disclosed embodiments describe systems and methods for providing real-time discounts. The disclosed systems and methods may include a memory storing instructions; and at least one processor configured to execute instructions. The instructions may include receiving entity information from a user device through an application. The user device may be configured to identify the entity information for at least one entity before a transfer at a vendor is completed. The instructions may include accessing at least one database containing discount information. The instructions may include determining which information of the discount information from the at least one database is associated with the entity information. The instructions may include providing, to the user device, the discount information through the application. The discount information may include at least one discount. The instructions may include applying the at least one discount before the transfer at the vendor is completed.

According to some embodiments, based on a geolocation of the user device, the user device may be determined to be located at a physical store.

According some embodiments, receiving the discount information may be initiated by a bank card automatically.

According to some embodiments, a bank associated with the bank card may automatically provide the discount retroactively.

According to some embodiments, the user device may be configured to operate a barcode scanner, and the entity information may be obtained using the barcode scanner.

According to some embodiments, the user device may be a smartphone.

According to some embodiments, the entity information may include at least one image obtained using a camera of the user device.

According to some embodiments, the entity information may include a representation of the at least one image. The representation may be obtained using image processing or compression.

According to some embodiments, the at least one image may not be an entity image.

According to some embodiments, the at least one image may include an identification of the at least one entity. The identification may include at least one of an alphanumeric code, a barcode, a QR code, a text description, and a brand name.

According to some embodiments, the at least one image may comprise at least one entity image.

According to some embodiments, the at least one entity image may be digital.

According to some embodiments, the at least one entity image may not be non-digital.

According to some embodiments, the entity information may be obtained using at least one neural network.

According to some embodiments, the at least one neural network may be trained using feedback from the user device. The user device may be configured to allow the user to select a match of the at least one entity and the entity information.

According to some embodiments, the at least one neural network may be trained using feedback from the user device. The user device may be configured to allow a user operating the user device to deselect a match of the at least one entity and the entity information.

According to some embodiments, the vendor information may include at least one of location, vendor type, competitor information, categories of entities sold by the vendor, or general sale information.

According to some embodiments, the user device may provide geolocation information to the processor.

According to some embodiments, the geolocation information may be used by the processor to identify discount information relevant to a location of a physical store in which the user device is located.

According to some embodiments, the discount information relevant to the location of a physical store may be provided to the user device automatically via a notification.

According to some embodiments, the discount information may be maintained by a third-party entity separate from the processor and the user device.

According to some embodiments, the discount information may include a barcode to be scanned during the transfer.

According to some embodiments, the discount information may include a discount code to be input during the transfer.

According to some embodiments, the discount information may be determined using at least one discount information neural network trained using feedback from a plurality of users operating a plurality of user devices.

According to some embodiments, the at least one discount information neural network may be further trained by monitoring activity associated with the discount information, the transfer, and the plurality of users.

According to some embodiments, the processor may further comprise a database configured to store transaction information associated with user information, the product information, the vendor information, and the discount information.

According to some embodiments, the user device may be configured to allow a user to access and modify the transfer information via the application.

According to some embodiments, the user device may be configured to allow a user to select a plurality of discounts for at least one entity and apply the plurality of discounts during the transfer.

According to some embodiments, the discount information may include one discount applied to a plurality of entities simultaneously.

According to some embodiments, the discount information may include information about a plurality of users using the discount.

According to some embodiments, if no discount is found, the discount information may indicate to the user that no discount was found.

According to some embodiments, the discount may be scored based on a success metric. The success metric may be based on the probability that the vendor will accept the discount.

According to some embodiments, if no matching discount is found, a potential discount may be provided in the discount information.

According to some embodiments, the potential discount may be scored with a success metric. The success metric may be based on the probability that the vendor will accept the potential discount.

The disclosed embodiments describe systems and methods for obtaining a discount. A sending device may be configured to receive input from a user through a discount application associated with the sending device. The input may include entity information for at least one entity for a transfer. A discount network operated by at least one server may include at least one database including at least one discount for the at least one entity. A receiving device may be configured to identify at least one discount corresponding to the at least one entity. The receiving device may be in communicative connection with the sending device to apply the at least one discount prior to the transfer.

According to some embodiments, the sending device may be determined to be located at a physical store.

According to some embodiments, a bank associated with the bank card automatically provides the at least one discount retroactively.

According to some embodiments, the sending device may be configured to operate a barcode scanner, and the entity information may be obtained using the barcode scanner.

According to some embodiments, the sending device may be a smartphone.

According to some embodiments, the entity information may include at least one image obtained using a camera of the sending device.

According to some embodiments, the at least one neural network may be trained using feedback from the sending device. The sending device may be configured to allow a user operating the user device to select a match of the at least one entity and the entity information.

According to some embodiments, the at least one neural network may be trained using feedback from the sending device. The sending device may be configured to allow the user operating the user device to deselect a match of the at least one entity and the entity information.

According to some embodiments, the sending device may provide geolocation information to the receiving device.

According to some embodiments, the geolocation information may be used by the receiving device to identify discounts relevant to the location of a physical store in which the sending device is located.

According to some embodiments, the discounts relevant to the location of a physical store may be provided to the sending device automatically via a notification.

According to some embodiments, the discount network may be maintained by a third-party entity separate from the receiving device and the sending device.

According to some embodiments, the at least one discount may be determined using at least one neural network trained using feedback from a plurality of users interacting with a plurality of sending devices.

According to some embodiments, the at least one discount information neural network may be further trained by monitoring activity associated with the discount network, the transfer, and the plurality of users.

According to some embodiments, the receiving device may further comprise a database configured to store transaction information associated with user information, the entity information, and the discount network.

According to some embodiments, the receiving device may be configured to allow a user to access and modify the transaction information via the discount application.

According to some embodiments, the sending device may be configured to allow a user to select a plurality of discounts for at least one entity and apply the plurality of discounts during the transfer.

According to some embodiments, if no discount is found, the discount network may indicate to the user that no discount was found.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 illustrates several potential users and a vendor of the system and methods consistent with the disclosed embodiments.

FIG. 2 illustrates a potential user using their user device to obtain discounts while shopping at a vendor, consistent with the disclosed embodiments.

FIG. 3 illustrates an example system environment for enabling a vendor transaction through a discount application, consistent with the disclosed embodiments.

FIG. 4 illustrates an example system environment for flow of information, consistent with the disclosed embodiments.

FIG. 5A illustrates an example system environment for identifying a discount for a product and providing the discount to a user, consistent with the disclosed embodiments.

FIG. 5B illustrates an example system environment for querying a user to determine if a discount for a product is a match, consistent with the disclosed embodiments.

FIG. 6 illustrates an example of a discount application on a user device, consistent with the disclosed embodiments.

FIG. 7 illustrates an exemplary method for providing a discount, consistent with the disclosed embodiments.

FIG. 8 illustrates an exemplary method for obtaining discount information, consistent with the disclosed embodiments.

FIG. 9 illustrates an example system environment for exchanging information between a sending device and a receiving device for a purchase using a discount, consistent with the disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence, or constrained to a particular system configuration. Additionally, some of the described embodiments or elements thereof can occur or be performed simultaneously, at the same point in time, or concurrently.

Reference will now be made in detail to the disclosed embodiments, examples of which are illustrated in the accompanying drawings.

The systems and methods described herein may include a real-time lookup of active discounts for a product using a scalable platform. Those discounts can be provided to a user on demand, saving the user money on a transaction. Furthermore, the user may be able to continuously access discounts at a variety of vendors for a variety of products either while they shop or as they perform a transaction, so the embodiments disclosed herein have the potential to save the user a substantial sum of money. This approach may replace the need for the user to go through the painful and time-consuming process of manually search for any possible discount available, either online or in person. The embodiments disclosed herein reduce the potential for lost opportunity cost associated with missing discounts.

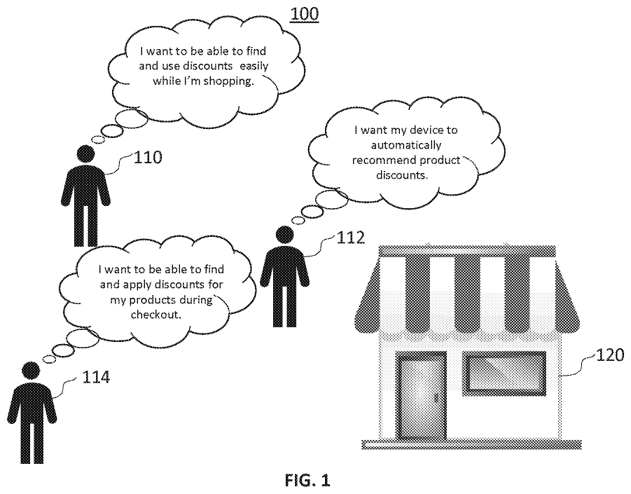

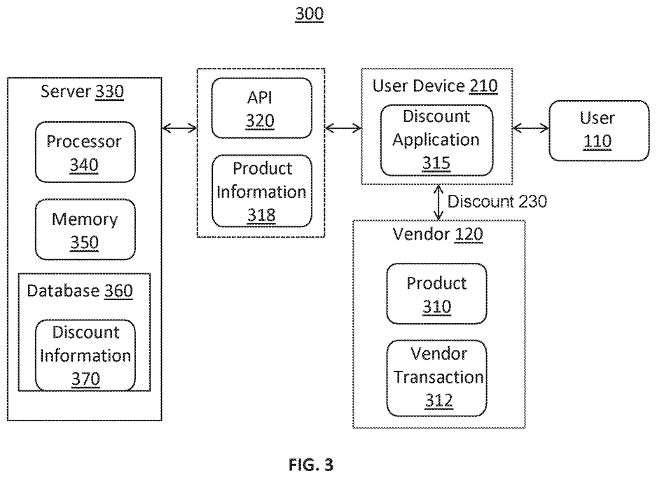

FIG. 1 illustrates several potential users 110, 112, and 114 and vendor 120, consistent with the disclosed embodiments. Each user 110, 112, and 114 is shown with a thought bubble demonstrating needs for obtaining discounts while shopping, that current solutions fail to address. As illustrated in FIG. 1, user 110 wants to be able to find and use discounts easily while shopping. User 112 wants their device to automatically recommend product discounts. User 114 wants to be able to find and apply discounts for products during checkout. For example, these needs may be addressed while user 110 is shopping at vendor 120. The users as illustrated in FIG. 1 may include any person actively or passively shopping. For example, the users may be a shopper in a physical store, or the users may be scrolling through a website on a computer device. Vendor 120 may be any entity involved in selling at least one product 310 (as shown in FIG. 3).

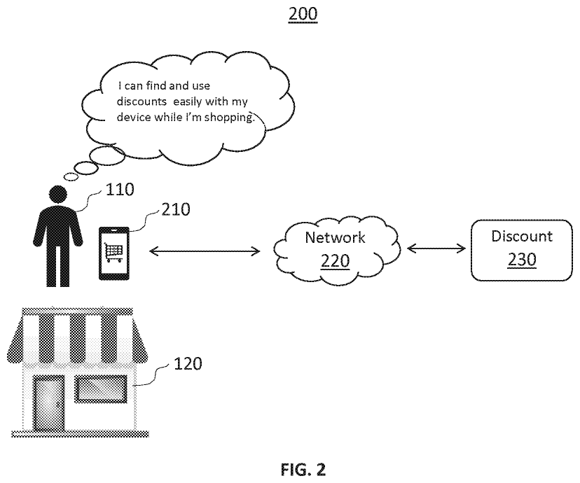

FIG. 2 illustrates a potential user 110 using their user device 210 to obtain discounts 230 while shopping at vendor 120, consistent with the disclosed embodiments. User device 210 may include any type of computer, smartphone, camera, or scanner (e.g. barcode scanner) operated by user 110. While shopping at vendor 120, user 110 may operate user device 210, which is configured to connect through network 220 to obtain discount 230. Network 220 may operate through wireless connections (e.g. Bluetooth or Wi-Fi), through wired connections (e.g. Ethernet), or any combination thereof. Discount 230 may refer to any reduction in cost of product 310 (shown in FIG. 3 and described below) during a purchase. For example, discount 230 may refer to any reward redeemed for a purchase (e.g. vendor transaction 312 shown in FIG. 3), such as a coupon, either in a digital (e.g. a digital code) or non-digital (e.g. a manufacturer's coupon) format.

FIG. 3 illustrates an example system environment for enabling a vendor transaction 312 through a discount application 315, consistent with the disclosed embodiments. Certain embodiments of FIG. 3 may have been previously described herein. User 110 may operate user device 210 to obtain information related to product 310 being sold by vendor 120. As used herein, products may refer to any goods or services that are available for exchange through a financial transaction (e.g. vendor transaction 312). For example, user 110 may purchase product 310 from a store. In another example, user 110 may purchase a service from a service provider. In some embodiments, user 110 may purchase product 310 from vendor 120, which may be any person, company, or entity offering product 310 for sale. User device 210 may interact with vendor 120 to perform vendor transaction 312 during purchase of product 310. User device 210 may provide product information 318 associated with product 310. Through an application programming interface (API) 320, user device 210 may communicate with server 330. Server 330 may comprise at least one processor 340, memory 350, and at least one database 360, wherein database 360 may comprise data including discount information 370. In some embodiments, user 110 may want to make a purchase and initiate communication with a source of discount information 370 related to the purchase. A source of discount information 370 may be database 360.

Discount information 370, as discussed previously, may refer to any information that can be used to identify discount 230. For example, discount information 370 may be data representing discount 230 in a way that enables a database search to find discount 230 when server 330 is queried with product information 318. In some embodiments, this data or information may be regularly updated in an automated manner. For example, data mining and data sifting operations may be performed using a plurality of discount sources to determine discount information 370. These discount sources may include, for example, third-party websites, manufacturers, competitor vendors, local offers, and user input. Data mining may include actively searching for available discounts in a variety of places (e.g. websites, advertisements, etc.) and incorporating discount information 370 associated with discount 230 into database 360. Data sifting may refer to filtering out discount data relating to discount information 370 or discount 230 when incorporating the discount data into database 360. Data sifting may also refer to filtering, removing, or updating the discount data in database 360. In some other embodiments, the data stored in server 330 may be updated using feedback from a user 110. For example, user 110 may input personal identification information associated with user information. For example, user 110 may input discount 230 into database 360 through server 330.

In some embodiments, vendor transaction 312 may occur at a physical store, such as vendor 120, as depicted in FIG. 1 and FIG. 2. Vendor transaction 312 may be any exchange of money for product 310. For example, vendor transaction 312 may be done at a self-checkout or a checkout operated by a cashier in a physical store. In some embodiments, user device 210 may be located in a physical store. A physical store may be a store where user 110 can physically enter and identify potential products for purchase. In some embodiments, vendor transaction 312 may occur online via a website.

The systems and methods disclosed herein may be operated or initiated by user device 210 that may be actively operated by user 110. In some embodiments, user 110 may not actively operate user device 210. For example, user device 210 may perform its functions automatically. For example, user device 210 may determine at which vendor 120 user 110 is shopping and API 320 may exchange information between user device 210 and server 330. API 320 may be a way for two computer programs or computer devices to interface. For example, API 320 may be software that enables backend software in a program to communicate with server 330, as discussed herein. API 320 may also operate in software separate from application 315. The software language may include any computer programmable language (e.g. C, C++, Javascript, Python). API 320 may be any interfacing software. For example, API 320 may include a representational state transfer (REST) API (e.g. in the form of a document API) operating locally or through a cloud network (e.g. network 220). For example, a document API may be operated through a cloud network to fetch barcodes for active coupons, which may be stored in the cloud network for ease of retrieval. A REST API may use a REST architecture that provides a list of options to user 110 following a search request. A REST architecture may be a software style designed for network-based applications. REST architecture is commonly used in scalable client-server applications. In some embodiments, user 110 may wish to find or search for discount 230 for product 310 and user 110 may initiate a request in discount application 315, which may communicate with server 330 through a REST API on network 220 to find and provide discount 230 to user 110 through user device 210. API 320 may operate through containerized API management. A containerized API may refer to a package or a bundling all files, code, libraries, and any other components involved in running API 320. For example, containerized API management may be handled by server 330 or associated with server 330. Containerized API management may refer to managing or maintaining the containerized APIs for deployment or implementation with user device 210 or API 320. In some embodiments, API 320 may include an integration API to facilitate communication between an end user device (e.g. user device 210) and server 330. Such communication may enable the operation of a real time reward redemption system. In some embodiments, APIs may be used to create a holding account for available funds for transaction reconcilement. Transaction reconcilement may include checking that a transaction and any exchange of money is valid. For example, before a purchase is completed, an API may check that a shopper has enough funds in their bank account to complete the transaction. In another example of transaction reconcilement, price verification of a product may be done to ensure that a discount was applied. APIs may also include generative artificial intelligence (AI) APIs for managing transactions. Generative AI APIs may be any API that interacts with generative AI models. Generative AI models may be any machine learning algorithms used to generate content. For example, generative AI APIs may be used to manage transactions automatically. For example, a transaction may be rejected if the transaction does not match a pattern of previous transactions.

A computer device may include server 330, user device 210, or any device or component operating computer programs or software. In some embodiments, API 320 may operate to perform its communications in the background, allowing background processing, which may be any operations that happen without user input. For example, API 320 may run in the background providing a communication link between user device 210 and server 330. User 110 may be aware that background processing is allowed, but when communication happens through background processing, user 110 may not be aware of the communication while it occurs. For example, user 110 may give permission through user device 310 or discount application 315 to enable background processing, and information may be automatically exchanged in the background while user 110 shops or performs other functions not related to operating discount application 315. Background processing may include performing functions in discount application 315 while user 110 shops. For example, background processing may include searching for discounts for products that may be associated with vendor 120, while user 110 shops. For example, background processing may use products identified by user 110 to search for similar products at vendor 120 to recommend to user 110 while shopping. Allowing API 320 to perform background processing may be advantageous, as operating in the background may allow API 320 to perform its functions faster and more efficiently.

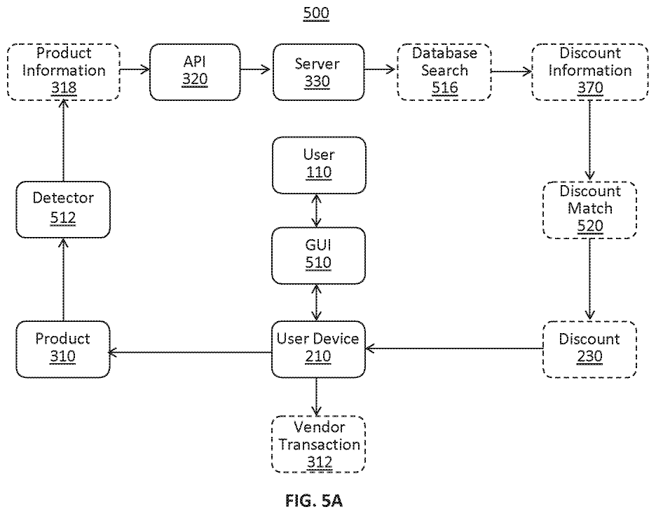

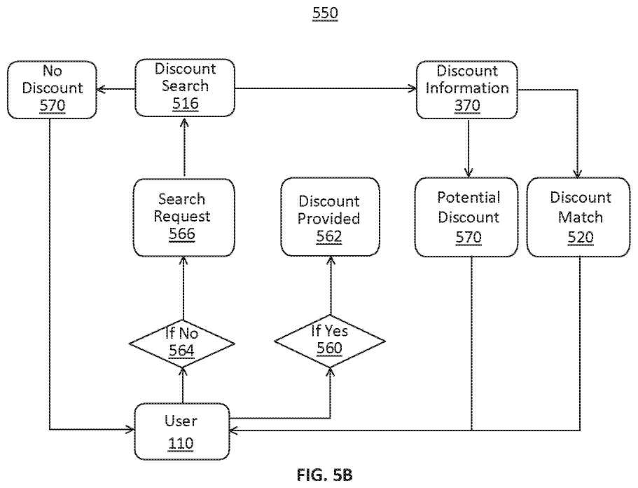

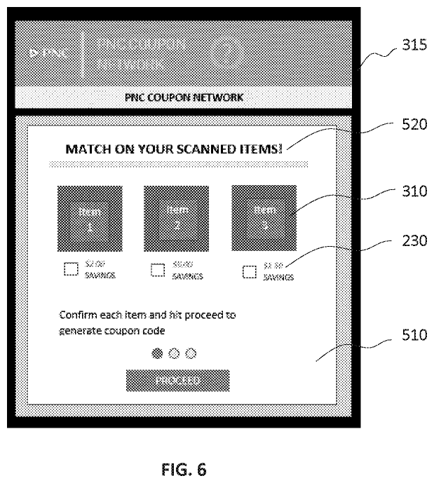

In some embodiments, multiple devices may be used by user 110, as described with respect to FIG. 5A. Multiple devices may refer to multiple user devices 210 or a combination of user device 210 and a complementary device that assists in obtaining discount 230, such as a system associated with a cash register at checkout. In some embodiments, user device 210 may be a smartphone. The smartphone, as described above, may operate various applications (e.g. discount application 315). FIG. 6 (described in further detail below) provides an example of discount application 315.

In some embodiments, product 310 may be identified using product information 318. User 110 or user device 210 may provide product information 318 to server 330, after which server 330 identifies the relevant discount 230 and informs the user 110. Product information 318 may refer to any representation used to identify product 310 in a way that allows server 330 or user device 210 to identify product 310. Product information 318 may include data, descriptions, images, brands, etc., associated with product 310. Product 310 may be identified using user device 210, API 320, or server 330. For example, user 110 may input a name of product 310 into discount application 315, which may develop a representation of product 310 using product information 318. In some embodiments, discount application 315 may include a search box for user 110 to search for product 310.

In some embodiments, a second device may be used to communicate with user device 210 to identify product 310. For example, a smartphone may be used to operate an application, and the smartphone may use a built-in camera or a barcode scanner that may be operated by the camera, or a second device that communicates with the smartphone. The smartphone (e.g. Apple iPhone™ or Samsung Galaxy™) may include any handheld mobile device that can operate as a computer with a touchscreen interface and can run applications (e.g. application 315). A second device may refer to any device engaged by user 110 that is not user device 210. Any second device may communicate directly with user device 210 through a wireless (e.g. Bluetooth or Wi-Fi) or wired connection (e.g. ethernet cable, universal serial bus cable, etc.).

In some embodiments, user device 210 may be configured to operate a barcode scanner, and product information 318 may be obtained using the barcode scanner. The barcode scanner may be a smartphone app or integrated with discount application 315 using a built-in camera on user device 210. For example, user 110 may activate a barcode scanner in discount application 315 to scan a barcode on product 310. In some embodiments, the barcode scanner may be a separate device that can communicate with the smartphone. In yet other embodiments, the barcode scanner may be a separate device with its own software that can communicate with server 330. For example, the barcode scanner may be a second device that can communicate directly with user device 210 through a wireless (e.g. Bluetooth or Wi-Fi) or wired connection. In any of these embodiments, the barcode scanner may operate using a decoder to interpret the lines on a barcode. The barcode may be on a physical product 310, or the barcode may be on a document (e.g. advertisement).

In some embodiments, receiving discount information 370 may be initiated by a bank card automatically. A bank card may be a credit card, debit card, or the like. A bank card may be associated with a bank account or credit account operated by a bank or financial institution and affiliated with user 110. For example, a debit card may be used to initiate vendor transaction 312, allowing server 330 to identify discount 230. For example, discount 230 for 10% off the whole purchase may be identified by server 330 for vendor 120 and provided to user 110 before vendor transaction 312 is completed. In such an embodiment, discount 230 may be applied directly through the bank card or API 320 at the point of sale, or administered via a rebate or refund through the bank network. For example, when using the bank card at a point of sale, user 110 may receive an immediate notification on their smartphone that discount 230 is available and that a rebate or refund may be available, and user 110 can seek this refund directly at vendor 120 or later via the bank operating the bank card.

In some embodiments, a physical bank card or a bank card stored on user device 210 may be used to initiate vendor transaction 312, and server 330 may automatically detect and apply relevant discounts 230 for products 310 associated with vendor transaction 312. Such a bank card stored on user device 210 may be a digital bank card. A digital bank card may refer to a copy or replacement of a bank card stored on a device (e.g. user device 210). For example, user device 210 may use a mobile payment service (e.g. Apple Pay™ or Google Pay™) to store and provide a digital bank card during vendor transaction 312. For example, server 330 may identify a list of products 310 associated with the purchase and may iteratively, or in parallel, search for discount information 370 associated with each product 310. Server 330 may automatically send this information to vendor 120 to provide and apply discount 230 to vendor transaction 312 at a point-of-sale. In some embodiments, a bank associated with the bank card may automatically provide the discount retroactively. For example, a financial institution associated with the bank card or server 330 may retroactively provide discount 230 in the form of a rebate, reward, or refund.

In some embodiments, discount application 315 may be configured to receive product information 318 from user device 210. Discount application 315 may be an application program on user device 210 designed to allow user 110 to obtain discount 230 related to product 310. Discount application 315 may function on user device 210, through API 320, or server 330. Discount application 315 may act as a liaison between user 110 and discount 230. For example, when user 110 wishes to find discount 230 for product 310, user 110 may scan product 310 into discount application 315, which may send product information 318 through API 320 to server 330, where discount information 370 may be obtained and provided to discount application 315 as discounts 230 for user 110 to choose whether to use.

User device 210 may run discount application 315 that interfaces with server 330 (e.g. a server at a bank or financial institution). Discount application 315 may include any software which can communicate in the software language of server 330. FIG. 6 depicts an example of discount application 315, which is described in further detail below.

Server 330 may include at least one processor 340 configured to execute computer codes or instructions stored in memory 350 to perform various functions. Memory 350 may be a non-transitory memory, such as a flash memory, a random-access memory, etc. Memory 350 may be configured to store data, such as computer codes or instructions executable by processor 340. The disclosed embodiments are not limited to any particular configuration of memory 350. Processor 340 may include various types of processing devices. For example, processor 340 may include a microprocessor, preprocessors (such as an image preprocessor), a graphics processing unit (GPU), a central processing unit (CPU), support circuits, digital signal processors, integrated circuits, processor memory, or any other types of devices suitable for running applications and for image processing and analysis. In some embodiments, processor 340 may include any type of single or multi-core processor, mobile device microcontroller, central processing unit, etc. Various processing devices may be used, including, for example, processors available from manufacturers such as Intel®, AMD®, etc., or GPUs available from manufacturers such as NVIDIA®, ATI®, etc. and may include various architectures.

Server 330 may contain software and hardware for performing its various functions related to providing discounts 230 to user device 210. For example, server 330 may comprise or control access to database 360. Database 360 may refer to an organized collection of information or data (e.g. structure data) stored electronically in a computer system or other storage medium. Database 360 may be a repository for storing, querying, and manipulating data (e.g. discounts 230), facilitating data-driven decision-making processes and supporting various applications and services. Database 360 may include tables, records, fields, keys, indexes, relationships, and any data values. Database 360 may be configured to enable efficient data storage, retrieval, and management operations. Database 360 may contain a variety of data related to user 110, product 310, and vendor 120. For example, server 330 may exist entirely or in part within a cloud-computing system or cloud network. In some embodiments, database 360 may be located on a separate server located on another network. In some embodiments, database 360 may be part of a third-party server system.

In some embodiments, discount 230 may be provided in real time. Real time may refer to providing discount 230 to user 110 through discount application 315 while user 110 is shopping at vendor 120. Real time may refer to the time during which shopping actively occurs. For example, discount 230 may be provided in real time during vendor transaction 312 or while user 110 is actively shopping before vendor transaction 312.

User 110 may operate user device 210 through discount application 315 with a graphical user interface (GUI). For example, a GUI may allow for touch, text, audio, or visual input, allowing the user 110 to engage with discount application 315 directly. For example, user 110 may be interested in purchasing product 310, and user 110 may input image, text, or other data associated with product 310 into discount application 315. Through API 320, discount application 315 may communicate with server 330.

In some embodiments, user device 210 may be configured to allow user 110 to select a plurality of discounts for at least one product 310 and apply the plurality of discounts during vendor transaction 312. When shopping, user 110 may choose multiple products they wish to purchase. A plurality of discounts may be displayed to user 110 on discount application 315, which may allow user 110 to redeem multiple discounts 230 at the same time. For example, user 110 may select/deselect individual products 230 within a list on discount application 315 (e.g. FIG. 6). These discounts 230 may be applied to at least one product 310 during vendor transaction 312 at a point of sale. For example, the plurality of discounts may be provided as a series of codes (e.g. barcodes) in discount application 315, and user 110 may input (or scan) each discount 230 into a checkout device. In some embodiments, a plurality of discounts may be applied using a single code (e.g. barcode). For example, a code (e.g. new code or alternative code that groups multiple discounts) may be generated that represents a combination of the plurality of discounts.

In some embodiments, server 330 may further comprise database 360, wherein database 360 may be configured to store transaction information associated with user information, product information 318, vendor information, and discount information 370. Database 360 may update any data associated with these sources of information. For example, discount application 315 (e.g. PNC Coupon Network shown in FIG. 6) may store, in server 330 or user device 210, information such as a coupon book, recent purchases, planned purchases, and total savings, which user 110 can access. Discount application 315 may, for example, proactively find and recommend coupons ahead of user device 210 performing vendor transaction 312.

In some embodiments, user device 210 may be configured to allow user 110 to access and modify information associated with vendor transaction 312 at vendor 120 via discount application 315. User 110 may also be able to access other forms of information, including user information, vendor information, or discount information 370 may also be accessed and modified. User 110 may be able to access only information related to user 110, and user 110 may be restricted from accessing data associated with other users. Server 330 may restrict access to some information while permitting other information on portions of database 360 to user 110 by implementing a login or verification of user 110. For example, after logging into discount application 315, discount application 315 may communicate with server 330 to allow user 110 to access portions of database 360. User device 210 may allow input in discount application 315 from user 110 to request access and modification of data. For example, permission may be given to user 110, by having user 110 input user credentials (e.g. login, password, user ID, personal information, etc.) for verification. After permission is granted, user 110 may be allowed to make changes directly through discount application 315 on their user device 210. For example, if user device 210 is running discount application 315 (e.g. FIG. 6), and user 110 wishes to remove a particular discount from database 360, discount application 315 may search for and allow user 110 to delete that particular data. For example, discount information 370 may be provided to user 110 via API 320 that allows the user to select relevant discounts on user device 210. In some embodiments, discount information 370 may include a barcode to be scanned during vendor transaction 312. For example, discount information 370 may be a barcode displayed on user device 210. The barcode from user device 210 may then be scanned at a checkout register to apply discount to product 310.

In some embodiments, discount information 370 may include a discount code to be input during vendor transaction 312. A discount code may refer to a string, vector, or visual (e.g. QR code) that can be used to redeem a discount at a point of sale. For example, discount information 370 from server 330 may include an alphanumeric code that user 110 types into a register or computer at a point of sale during vendor transaction 312 (e.g. self-checkout). Alternatively, user 110 may provide a cashier with a discount to be applied during vendor transaction 312.

In some embodiments, discount information 370 may be maintained by a third-party entity separate from server 330 and user device 210. A third-party entity may refer to any provider of discount information 370 that is separate from user 110, user device 210, or server 330. The third-party entity may include vendor 120 providing discount 230 on-demand, either while shopping or at a point of sale. A third-party entity may also refer to a separate company that specializes in identifying and providing information that may help aggregate discount information 370.

In some embodiments, discount information 370 may be determined using at least one discount information neural network trained using feedback from a plurality of user operating a plurality of user devices. In some embodiments, discount information 370 may include information about a plurality of users using a discount. The neural network may be a neural network, trained on previous data related to discount information 370. For example, a neural network may be used to predict, using expired discounts and user discount history, when a discount may occur again. For example, discount application 315 (or user device 210) may display a notification of a discount to user 110 with a message reading, “This item was just on sale on the last four consecutive Sundays for 20% off.” In some embodiments, a neural network may be trained using feedback from user 110 operating user device 210. For example, user 110 may routinely select to ignore a particular category of discounts, such as a buy-on-get-one free discount. In some embodiments, a neural network may be further improved by monitoring activity associated with discount information 370, vendor transaction 312, and user 110.

In some embodiments, discount information 370 may include one discount applied to a plurality of products simultaneously. For example, a 10% off coupon may be identified by server 330 and provided to user device 210 may be applied to all of products 310 user 110 purchases during vendor transaction 312 at a point of sale.

In some embodiments, discount information 370 may be supplied to vendor 120 directly during vendor transaction 312. Server 330 may be able to communicate directly with a device associated with vendor 120 to allow user 110 to redeem a discount. For example, user 110 may access and redeem a discount through network 220 on a checkout device or online (e.g. using discount application 315 or a shopping cart on a website) and network 220 may communicate directly with server 330 to find and apply any relevant discounts. Vendor 120 may also implement a device used to identify and obtain a discount relevant to product 210, while user 110 is at the checkout.

In some embodiments, discount information 370 may be supplied to user device 210 while user 110 is still shopping. Discount information 370 may contain information used to apply discount 230. Products 310 may be uploaded continuously via user device 210 while user 110 is shopping. For example, user 110 may take several photos of products 310 while browsing in vendor 120. Discount application 315 may receive a plurality of photos and server 330, in turn, may generate a list of discounts for user 110 to search later (e.g. during checkout). For example, discounts may be collected and provided to user 110 on demand or during vendor transaction 312 at a point of sale.

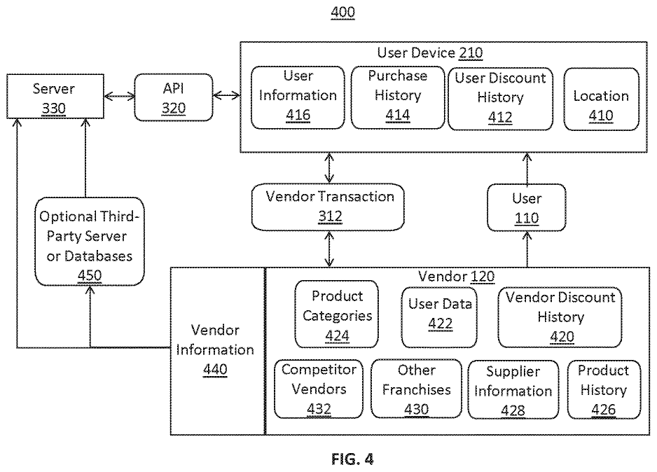

FIG. 4 illustrates an example system environment 400 for flow of information, consistent with the disclosed embodiments. Certain embodiments of FIG. 4 may have been previously described herein. In some embodiments, data (e.g. product information 318 and discount information 370, as described with respect to FIG. 3) may be shared between the user device 210 and server 330 or the vendor 120 and server 330. As described with respect to FIG. 2, user 110 may operate user device 210, which may store or provide data, such as user information 416, purchase history 414, user discount history 412, and location 410, as shown in FIG. 4. These examples of information are merely exemplary and there may be other data associated with user device 210. User 110 may select at least one product 310 from a vendor 120. User device 210 may be used to identify or characterize product 310 (e.g. obtaining product information 318 using detector 512, as described with respect to FIG. 5). User device 210 may engage with vendor 120 through user 110 (e.g. during shopping or vendor transaction 312). User device 210, through API 320, may communicate the identified product 310 with server 330. In some embodiments, data such as vendor information 440 may be stored on a separate server. In some embodiments, vendor information may also be provided to server 330 for storage, or, optionally, to at least one optional third-party server or database 450. For example, discount information may be provided to user device 210 via a notification (e.g. push notifications, badges, banners, alerts). For example, vendor information 440 may include product categories 424, vendor location, user data 422, vendor discount history 420 (for product 310 or for vendor 120), competitor vendors 432, other franchises 430 affiliated with vendor 120, supplier information 428, and product history 426, as described in further detail below.

In some embodiments, the data stored by server 330 may include at least one of vendor information 440 for a plurality of vendors, user information 416 for a plurality of users, or discount information for a plurality of discounts. User information 416 may refer to a user's name, address, user identification (UID), bank account, shopping preferences, device information, telephone number, login credentials, network information, location, etc.

User device 210 may provide location 410 of vendor 120 or user device 210. Location 410 may be determined by a reported address, such as on a company website, a third-party mapping company (e.g. Google Maps™), or user device 210. In some embodiments, user device 210 may provide geolocation information to the processor (e.g. for server 330). For example, user device 210 may have an enabled geolocation device or sensors using a global navigation satellite system (GNSS), such as global positioning system (GPS). Providing geolocation information to server 330 may allow a discount application to access discounts automatically based on location 410 of user device 210. Geolocation (e.g. location 410) may refer to any country, region, state, city or postal code. Geolocation may be inferred from position relative to satellites, nearby cell towers, nearby devices, internet protocol (IP) addresses, etc. Geolocation may also be determined by assisted GPS. In some embodiments, discount information associated with location 410 may be provided automatically to user device 210 via a notification (e.g. push notification, banner, badges, alerts). Discount information may alternatively be provided following a request by the user, where the request was initiated automatically by server 330. In some embodiments, based on a geolocation of the user device, the user device may be determined to be located at a physical store. In some embodiments, the geolocation information may be used by the processor to identify discount information relevant to a location of a physical store in which the user device is located. For example, when user 110 steps into a physical brick and mortar store, geolocation information from user device 210 may be sent to server 330 automatically, and server 330 may provide discount information relevant to that physical store to user device 210 without any direct input from user 110. In this example, a discount application may provide discount information 370 directly to user 110, or discount application 315 may provide a request to show discount information to user 110 on user device 210, which user 110 can then choose to allow or disallow. In some embodiments, server 330 also may receive vendor location information through vendor information 440.

Geolocation may also be used to prevent fraud by determining if location 410 of user device 210 matches a known location that is commonly used by user 110. For example, server 330 may maintain database 360 of user information 416 that may include a list of IP addresses associated with user device 210, and any previously traveled locations 410. Geolocation access by a discount application may be turned on or off by user 110. For example, if geolocation is enabled (i.e. turned on), the discount application may determine which store that user 110 has entered and, in the background or when prompted, automatically search a database for discounts relevant to products sold at vendor 120 and present them to user 110 on the discount application. For example, geolocation may be used to identify discounts (e.g. manufacturer's coupons or vendor-specific discounts) that may be location-dependent or otherwise restricted for use by location. Such a feature may be enabled or disabled by the user. For example, user 110 may wish to disable the discount application from running in the background. User 110 may change permissions for location tracking on user device 210. User 110 may toggle the location tracking on or off. Changing permissions may be done through a discount application or through the operating system of user device 210.

In some embodiments, a product may be associated with vendor information 440, which may include at least one of vendor location, vendor type, information on competitor vendors 432, product categories 424 sold by vendor 120, or general sale information. Vendor location may be a physical location of vendor 120. Vendor location may be provided directly by address information included in vendor information 440. Vendor location may refer to the geolocation described above in relation to location 410 obtained by user device 210 or by a third-party mapping company, or by a method of determining geolocation separate from user device 210. For example, vendor location may be determined using a known address of vendor 120. Vendor type may be a category of vendor 120. Vendor type may be determined by products sold at vendor 120. Vendor type may refer to grocery, retail, mall, beauty, pharmacy, clothing, sporting goods, automotive, theaters, entertainment venues, etc. In some embodiments, vendor information 440 may be used to make recommendations to user 110 through a discount application on user device 210 about where they shop and where better deals may exist. For example, a discount application may notify user 110 that a product user 110 is interested in purchasing is available for 50% off at another vendor (e.g. competitor vendor 432, described in further detail below).

In some embodiments, vendor information 440 (or discount information) may be aggregated by optional third-party server or databases 450. This aggregated information may be a collection of vendor information 440 from a plurality of vendors 120, discount information from a plurality of discounts, or a combination thereof. The aggregated information may be provided to server 330. For example, discount application 315 may be maintained by one entity, but server 330 may not directly obtain vendor information 440, and instead an optional third-party server or databases 450 may be used to obtain or provide vendor information 440 (or discount information 370). In some embodiments, optional third-party server or databases 450 may include a server operated by another company or entity (e.g. Amazon Web Services™ database services or Microsoft SQL Server™). In another example, optional third-party server or databases 450 may be a discount network server operated by another company or entity and enabled to supply vendor information 440 to server 330. In this example, server 330 may provide a request to receive the aggregated information and enable optional third-party server or databases 450 to send the aggregated information.

Various information affiliated with user 110 may be collected or shared by the user device 210. One form of information that might be shared with server 330 is purchase history 414 of user 110. For example, purchase history 414 may refer to how frequently a product is purchased by a user from a particular vendor 120, or how many products are purchased simultaneously. Purchase history may also include the price for a product, dates of purchase, quantity purchased, frequency of purchase, purchase of similar items, in a scenario where user 110 has purchased the product more than once. User discount history 412 may be shared with server 330. User discount history 412 may refer to any discounts user 110 has selected or applied to a vendor transaction previously. In other embodiments, user discount history 412 may refer to any discounts user 110 has not applied to a vendor transaction. For example, user discount history 412 may include types of discounts a user, such as what user 110 typically selects or deselects.

Vendor information 440 may include product categories 424. Server 330 may collect vendor information 440 from at least one vendor 120 related to the sale of at least one product. Products may be affiliated with various product categories 424. Product categories 424 may refer to groupings or classifications of products that share common characteristics. For example, product categories 424 may include equipment, beauty products, raw materials, components, food, etc. Characteristics of products used for forming product categories 424 may include brands, product use, or type of product. Product categories 424 may be determined by vendor 120, server 330, a third-party entity, or user input. Product categories 424 may be updated automatically by aggregating information from various online sources (e.g. through network 220) or databases storing information characterizing products.

Vendor information 440 may include user data 422. User data 422 may refer to any data collected by (or associated with) shopping for products at vendor 120. User data 422 may include overlapping data with user information 416. In some embodiments, user data 422 may contain different data from user information 416. For example, user information 416 may contain personal information that overlaps with personal information in user data 422. For example, user information 416 may contain more private information such as login credentials (e.g. for discount application 315, as shown in FIG. 3) which would not be available with user data 422. User data 422 may come from at least one user 110. For example, a plurality of users shopping at vendor 120 may use a discount application for obtaining a discount, and user data 422 from the plurality of users may be provided in vendor information 440 and stored in server 330. In some embodiments, information relating to user data 422 applying a discount to a product may be provided to user 110 a user interface. User data 422 may also include other products, other discounts, or other vendors with at the plurality of users frequently shop.

Vendor information 440 may also include information about competitor vendors 432. Competitor vendors 432 may include vendors that are in direct competition with at least one product or product category 220 for vendor 120. Competitor vendors 432 may be determined by data provided from repositories (e.g. data library, data archive, or other storage space) and accessed by server 330. Such repositories may include data associated with vendor information 440 that can be used to compare a plurality of vendors categorized based on vendor characteristics such as industry, field, types of products sold, etc. Competitor vendors 432 may also be determined by a neural network or other AI models. Data related to a plurality of vendors may be used to train or continually update the neural network. For example, a neural network may be used to assess vendor characteristics to categorize the plurality of vendors and predict competitor vendors 432 relative to vendor 120. Using such a neural network (or other AI models), competitor vendors 432 may be determined automatically by server 330 or optional third-party server or databases 450. AI models may include large language models, generative AI algorithms, random forests, K-means, K nearest neighbors, etc. The AI models may be supervised or unsupervised. Supervised models are trained using a labeled (known) data set. Unsupervised models may be trained using unlabeled data.

Vendor information 440 may also include vendor discount history 420 of vendor 120. Vendor discount history 420 may be a record of any previous discounts vendor 120 or manufacturer has allowed for a product. Vendor discount history 420 may also include any record of discounts that users have used successfully or attempted to use unsuccessfully. Vendor discount history 420 may include historical discounts that have been used for a product (or product categories 424), dates of previous discounts, number of previous discounts, price-matching discounts (e.g. matching the price of a competitor vendor 432). In some embodiments, vendor discount history 420 may be used to make predictions about the occurrence or an amount of future discounts. Such predictions may involve the use of neural networks or other AI models. Other AI models may include large language models, generative AI algorithms, random forests, K nearest neighbors. The AI models may be supervised or unsupervised.

Vendor information 440 may also include other franchises 430. Vendor 120 may be associated with other franchises 430, which may refer to other locations (or websites) where a product can be purchased. For example, user 110 may be shopping at a McDonald's™ franchise, and server 330 may identify a coupon that is available at another McDonald's™ franchise and provide user 110 with the coupon. In this example, user 110 may also be notified through a discount application that staff will need to be informed to honor the coupon.

Vendor information 440 may also include supplier information 428. Supplier information 428 may refer to any information that helps to identify a supplier of a product to vendor 120. For example, supplier information 428 may include supplier name, supplier address, supplier shipments, other vendors (e.g. competitor vendors 432) supplied, cost of a product to the supplier, etc. Supplier information 428 may include the manufacturer of a product or any third-party supplier that acts as an entity of trade before the product arrives at vendor 120. Supplier information 428 may also be obtained by server 330 aggregating and analyzing data related to the purchasing, stocking, and sale of a product from a plurality of vendors. For example, supplier information 428 may be supplemented by third-party sources aggregating the data. In some embodiments, server 330 may obtain supplier information 428 and use supplier information 428 to identify alternative vendors (e.g. competitor vendors 432 or other franchises 430) for user 110 to purchase an identical product at a discounted price.

Vendor information 440 may also include product history 426. Product history 426 may refer to availability of a product at various points in time, fluctuations in price, alternative names, etc. Product history 426 may also include dates when a product has gone out of stock or when the product was in stock.

In some embodiments, product information may be obtained using at least one neural network. A neural network may refer to any machine learning process related to deep learning AI models. Machine learning methods, and more complex AI methods, such as deep learning and neural networks, may be used to make predictions with adaptations that allow for a continually improving selection process for a product, involving the identification and characterization of product information. The at least one neural network may have been trained on previous user data (e.g. user information 416, product data, (e.g. product matching), image data, or discount data (e.g. discount matching). The at least one neural network may be iteratively updated based on user information 416 provided to server 330 (e.g. new user information continually added to a database). The at least one neural network may be initiated or performed by user device 210, API 320, or by server 330. For example, user device 210 (or API 320 or server 330) may run a convolutional neural network or other AI model to perform image processing. A convolutional neural network may be a class of deep learning neural network. As used herein, a convolutional neural network may be a neural network that uses a series of layers to perform image analysis on digital images. For example, a convolutional neural network may be used to predict or assign product information for a product and classify images associated with product information or the product. In some embodiments, user device 210 may provide a product image or product information to server 330, which may run at least one neural network to perform a product match (e.g. matching a product to product information) or a discount match (e.g. matching a discount to a product). A product match may be a correlation between a product and product information. When a product match does not occur (e.g. no correlation is found between a product and product information), an error message may be provided through discount application, or a request for additional input related to the product from user 110 may be made through the discount application. Vendor information 440 may be used as inputs to further improve the neural network predictions for product information. For example, vendor discount history 420 may be used to improve predictions for product information made by the neural network by analyzing previous discounts used by vendor 120. Other AI models may also be used for any of the processes involving neural networks described herein, including random forests, decision trees, regression models, etc. Furthermore, AI models implemented in embodiments of this disclosure may include use of active learning, in which during deployment, feedback from the field of users 110 is used to continually improve the AI model's performance.

In some embodiments, a neural network may be trained using feedback from user device 210. Consistent with these embodiments, user device 210 may be configured to allow user 110 to select a match of a product and product information. For example, a discount application may prompt user 110 to select whether product information matches the product that user 110 wished to purchase. If user 110 selects that product information is incorrect (i.e. not matching the product), then server 330, user device 210, or API 320 may be prompted to search for additional or different product information. In yet other embodiments, a neural network may be improved using feedback from the user device, wherein the user device is configured to allow the user to deselect a match of the at least one product and product information by user 110 operating user device 210, wherein user device 210 may be configured to allow user 110 to select a match of the product and the product information.

A discount match may be determined by user 110 selecting a discount provided by server 330 for a product for purchase. Server 330 may receive and store information for past and present purchases for products and discounts used by user 110 or other users. In some embodiments, server 330 may use a neural network (or any AI model or machine-learning process) to improve a prediction of a discount match of a discount to a product. Such a neural network may be trained on previous data associated with selection of a discount for a product by user 110. Server 330 may use such embodiments to apply discounts to various products from various vendors.

FIG. 5A illustrates an example system environment 500 for identifying discount 230 for product 310 and providing discount 230 to user 110, consistent with the disclosed embodiments. Certain embodiments of FIG. 5A may have been previously described herein. User 110 may interact with user device 210 through graphical user interface (GUI) 510. GUI 510 may include inputs based on touch, text, speech, images, etc. For example, inputs may include an uploaded image or a voice-to-text search box. User device 210 may obtain product information 318 from product 310, using detector 512. Detector 512 may refer to any device that can be used to detect features associated with product 310. For example, detector 512 may include an imaging device (e.g. camera) or a scanner (e.g. barcode scanner). In some embodiments, this camera may be on a smartphone. In some other embodiments, user device 210 may include a barcode scanner hardware or software (e.g. a smartphone app). Detector 512 may relay product information 318 to server 330 through API 320. Server 330 may perform database search 516 for any discount 230 applicable to product 310. Database search 516 may include a search in database 360 for discount information 370 to identify at least one discount 230. When at least one discount 230 is identified, discount 230 may be provided to user device 210, which may communicate discount 230 to user 110 through GUI 510 (on discount application 315). User 110 may select, through GUI 510, whether to accept or reject the at least one discount 230 (as shown in FIG. 5B), after which discount 230 may be provided to be applied at checkout during vendor transaction 312.

Discount match 520 may be a match for a discount provided by server 330 and verified or selected by user device 210 or user 110 (e.g. through discount application 315, as shown in FIG. 3). Discount match 520 may refer to discount 230 that matches product 310 or satisfies the expectations of user 110. For example, expectations of user 110 may be determined by feedback from user 110 through a discount application. A discount application may allow user 110 to select (through GUI 510, discussed in further detail below) discounts 230 provided by server 330. Discount match 520 may occur when user 110 selects and uses discount 230 (e.g. uses it for vendor transaction 312). For example, server 330 may receive product information 318 for product 310 provided by user 110, and server 330 may search for discounts 230 for product 310, send discount information 370 for discount 230 to discount application 315, on which user 110 may select and apply discount 230 to vendor transaction 312, resulting in discount match 520 between discount 230 and product 310. Additionally, discount match 520 may be stored in server 330 (e.g. database 360) for future use. For example, a user discount history may include types of discounts a user typically selects or deselects, discount matches 520 that were successfully applied (or unsuccessfully applied), or overall savings information (e.g. total saved from applied discounts). In some embodiments, a user discount history may include a user deselecting discount 230 that was identified by server 330 to be a discount match 520 for product 310 based on discount information 370. In that situation, the user may input their reason for deselecting discount 230, enabling server 330 to update a database for future use. GUI 510 may enable user 110 to select/deselect discounts 230 from the list. For example, GUI 510 may have checkboxes (e.g. FIG. 6) to select/deselect discounts 230.

In some embodiments, product information 318 may include at least one image obtained using a camera (e.g., detector 512). The image may be any particular orientation of product 310 that comprises enough relevant information to identify product 310. For example, the image may contain at least one of product 310 brand logo, brand name, product name, product graphics, or any orientation of product 310. In some embodiments, multiple images may be obtained and used to identify product 310. For example, multiple orientations may be used. In some embodiments, the image may include a barcode. For example, the system may enable user 110 to do a final lookup for relevant discounts 230 at the point of sale on a self-checkout machine. In this example, user 110 may use user device 210 to take an image of the products 310 listed on the self-checkout machine to search for relevant discounts 230. The system may also enable user 110 to do a lookup for at least one product while shopping in a physical store (e.g. vendor 120 in FIG. 1).

In some embodiments, product information 318 may include a representation of the at least one image using image processing or image compression. The image may be obtained by detector 512. The image may be a digital image with pixels representing each individual element in the image. Pixel may be the smallest element in a digital image. Image processing may refer to any processing of data related to the digital image. For example, image processing may alter a matrix of pixel values, including red green blue (RBG) color intensities, grayscale values (e.g. white to black scale), or pixel intensity (e.g. overall brightness of a pixel). Color intensity may be the relative strength or intensity of each color (e.g RBG) for each pixel. A representation may be any change of at least one value (e.g. the values defined above) in an image from detector 512. For example, a compressed version of the image may be used. A compressed image may be a modification of the digital image in which a storage size (e.g. file size on a computer hard drive) of the digital image is reduced. A compressed image may be obtained using image compression using lossy compression or lossless compression. Image compression may cause a reduction in digital image size by removing image data. Image data may be at least one value associated with at least one pixel in the digital image. Lossy compression may be a compression in which some image data (e.g. some pixel values) are lost during compression. Lossless compression may be image compression in which no image data is lost. In other examples, a representation may be a binary, bitmap, vector, or color image. The representation may speed up communication between and analysis by user device 210 and server 330. For example, the representation may also reduce storage file sizes for future use and reference using data compression.

In some embodiments, an image may comprise at least one product image. A product image may be included in product information 318 provided by detector 512. A product image may be an image on a document, such as an advertisement or a computer screen. For example, user 110 may be browsing in a shop and find an image of product 310 of interest on a store brochure. By taking an image of the product image, user 110 can immediately search for relevant discounts 230 through GUI 510 using a discount application and improve their shopping efficiency. User 110 may take a photo of a product using detector 512 and upload the photo into a discount application on user device 210. The discount application may then identify and relay product information 318 through API 320 to server 330. Server 330 then may perform a database search 516 to obtain discount information 370, providing a discount match 520 to product 310, and providing discount 230 to user device 210, which may display discount 230 through GUI 510 to user 110 for use in vendor transaction 312.

In some embodiments, a product image may be digital, and in yet other embodiments, a product image may be non-digital. A digital image may refer to any image that is displayed on a screen. For example, if user 110 is browsing a website on a desktop computer and finds product 310 of interest, user 110 may take an image of the product image with their user device 210. A non-digital image may refer to any image that is not displayed on an electronic screen. A non-digital image may refer to an image on an advertisement, brochure, package, etc. For example, user 110 may browse through a brochure, identify product 310 of interest, take an image of a non-digital image of product 310, and initiate a search for discount 230 in s discount application.

In some embodiments, an image may not include a product image. For example, an image may include a category of items or a general description of an item that may be used to infer reference product 310. In some embodiments, the image may include an identification of product 310. Consistent with these embodiments, the identification may include at least one of an alphanumeric code, a barcode, a QR code, a text description, and a brand name. An alphanumeric code may refer to any string of letters or numbers that can be used as a label to identify an entity, or in this case product 310. For example, a stock-keeping unit (SKU) code may be used to identify product 310. A QR code may refer to any two-dimensional matrix barcode. A text description may refer to any words used to refer to or describe product 310. A brand name may refer to any title of product 310 or its manufacturer's name. Any of these means may be used individually or in combination. For example, an image of a text description of product 310 may be used in combination with a manufacturer's brand name to identify product 310 and provide discount information 370 to user device 210.

FIG. 5B illustrates an example system environment 550 for querying user 110 to determine if a discount for a product is a match (e.g. discount match 520), consistent with the disclosed embodiments. Certain embodiments of FIG. 5B may have been previously described herein. After a server receives product information from a user device, the server may perform discount search 516. Discount information may be found and a discount with high confidence may be provided as discount match 520 to user 110. For example, if user 110 has previously selected a discount for a product, the discount may be provided for a purchase where the same product is identified. Discount information may be found and potential discount 570 identified by the server may be sent to the user device. GUI 510 may be configured through a discount application to prompt user 110 through the user device to select whether user 110 wishes to use potential discount 570 for a product. Selecting potential discount 570 for a product may be confirmation of a match for a discount to be applied to a purchase. For example, one choice may be “yes,” and the other choice may be “no.” In some embodiments, if a predetermined condition is met, and user 110 selects to use potential discount 570, then the condition for if yes 560 is met. If yes 560 is met, potential discount 570 may be provided as a discount for vendor transaction 312 during discount provided 562. During discount provided 562, discount 230 may be provided to user 110 through a user device to be applied during a purchase of a product. After discount provided 562, potential discount 570 may be reassigned by the server to be a discount for use in the future as discount match 520.

If a predetermined condition is met, and user 110 selects not to use potential discount 570 (e.g. does not select any checkbox in FIG. 6), then the condition for if no 564 is met, and the user device may send search request 566 for a different discount to the server. Search request 566 may cause the server to search a database for an alternative discount to provide to user 110. After search request 566, the server may be configured to determine whether another discount search should be performed in discount search 516. The server may be configured to cease discount search 516 if a discount is not found, a predetermined timeout occurs (e.g. a designated search time established by the server), user 110 terminates the search, etc. If the search ends, the server may be configured to provide no discount 570 to the user device for user 110, and the search ends. For example, the server may note that a previous discount search resulted in only one possible discount, and so in the current discount search, there will be no discount 570. If discount search 516 should continue, then the server may perform discount search 516 for discount information 370 and continue to identify potential discount 570 to provide a discount to user 110 for a vendor transaction.

In some embodiments, if discount match 520 is not found, potential discount 570 may be provided in the discount information. A potential discount may refer to a discount identified by server 330 to be a possible match to product 310, but where discount match 520, has not been identified. In some embodiments, there may not be enough history in discount information or vendor information of successful use of discount 230 for product 310. The potential discount may not lead to a discount being successfully applied at the point of sale. For example, potential discount 570 may be a 10% off coupon that the a server has identified, but the coupon may not be verified to have worked successfully in the past. In some embodiments, if no potential discount is identified, the server may return no discount 570 to a user device. This may cause the server to re-initiate discount search 516.

In some embodiments, potential discount 570 may be scored based on a success metric, wherein the success metric is based on the probability that vendor 120 will accept the discount or the potential discount 570. Scoring may be done based some accessed value associated with previous information. For example, a look-up table may be used, where the values (e.g. scores or success metric) in the table are based on successful matches obtained previously by user 110 (or any of a plurality of users). A look-up table may contain relevant values in cells of columns or rows with their positions previously determined for easy access. For example, memory may preload the values and their positions in the table to improve the accessibility and speed of identifying potential discount 570 based on the success metric. For example, a neural network (or other AI models) may be used to be determine the success metric and assign a score using predictions based on data related to similar discounts. In some embodiments, the score may be determined by a machine-learning model, including (but not limited to) linear regression, Bayesian inference, support vector machine, K-nearest neighbor, gradient boosting, neural networks, etc. The score may be, for example, a percentage value, or a range from 1-10. A discount application may enable user 110 to provide feedback on a discount, which may increase or decrease the success metric. If the score decreases, the discount may be recharacterized by a server as a discount with a lower probability of success. Alternatively, a higher scoring discount may result in the server reassigning potential discount 570 to a discount for use as discount match 520. User 110 may also provide a score for a discount matched during discount match 520, which may result in changing the discount to potential discount 570 for future use.

In some embodiments, potential discount 570 may be scored with a success metric, wherein the success metric is based on the probability that the vendor will accept the potential discount. For example, if a 10% off coupon has not been performed successfully in the past, a success metric may be determined and the coupon may be assigned a score of 50%, reflecting a 50% chance that vendor 120 will accept discount 230 at the point of sale. For example, if a potential discount is scored too low, server 330 may return no discount 570 to a user device. A discount application may enable user 110 to provide feedback on the potential discount, which may increase or decrease the success metric.

In some embodiments, if no discount 570 is found, discount search 516 may indicate to user 110 that no discount 570 was found. For example, the message may be a notification on user device 210 (e.g. in discount application 315, as shown in FIG. 3). In some embodiments, if a discount match is not successful, a possible discount may be provided. In some embodiments, a possible discount may be scored with a likelihood of success. In some embodiments, the likelihood of success may refer to a probability that a discount may be successful (i.e. accepted and used by user 110 for a vendor transaction). The likelihood of success may be used to make predictions about which discount to recommend to user 110 in the future. For example, a likelihood of success may be a probability determined by analyzing performance of similar, previously used discounts. In some embodiments, a plurality of users may provide feedback through a plurality of user devices through a discount application. In some embodiments, feedback from a plurality of users may be used to predict the likelihood of success. Feedback may be aggregated from the plurality of user devices into a database for analysis. For example, the plurality of users may input through a GUI whether each possible discount (e.g. from a pool of previous possible discounts) was successfully applied to a vendor transaction. In some embodiments, the likelihood of success may be determined by a machine-learning model, including (but not limited to) linear regression, Bayesian inference, support vector machine, K-nearest neighbor, gradient boosting, neural networks, etc.

In some embodiments, if no discount 570 is found, a message may be relayed to user 110. For example, the message may be displayed on a discount application and say “Apologies, but no discount has been found for this product.” The message may be a pop-up notification displayed on user device 210 or over a GUI. A pop-up notification may be any notification overlaid on top of applications and displayed to user 110. For example, a pop-up notification may be a message of no discount found that is displayed in a box over a GUI. The message may also include a statement that user 110 can initiate a search request 566 from a server, and a discount application may allow user 110 to input their selection. For example, a GUI may include options to receive input from user 110 regarding their selection. The input may include checkboxes, yes/no responses, buttons, drop-down menus, voice input, etc.

FIG. 6 illustrates an example of discount application 315 on a user device, consistent with the disclosed embodiments. This is a non-limiting example intended only to demonstrate one possible implementation of some of the disclosed embodiments. Discount application 315 may use GUI 510 to interface with a user through a user device. In this example, discount application 315 is called PNC Coupon Network and may operate to aid a user in providing discounts 230 on some products 310 (e.g. items) of interest. On the backend, an API may communicate with a server (e.g. a server at PNC bank), which provides the discounts 230 as options to the user. Discount application 315 may allow the user to select/deselect checkboxes, which each checkbox corresponding to each product 310 (e.g. item 1, item 2, item 3). Discount application 315 may also display the amount of each discount 230 (e.g. savings). The user may be prompted to confirm each discount 230 for each product 310 to generate at least one code that can be used to apply the discount(s) at the point of sale (not shown).

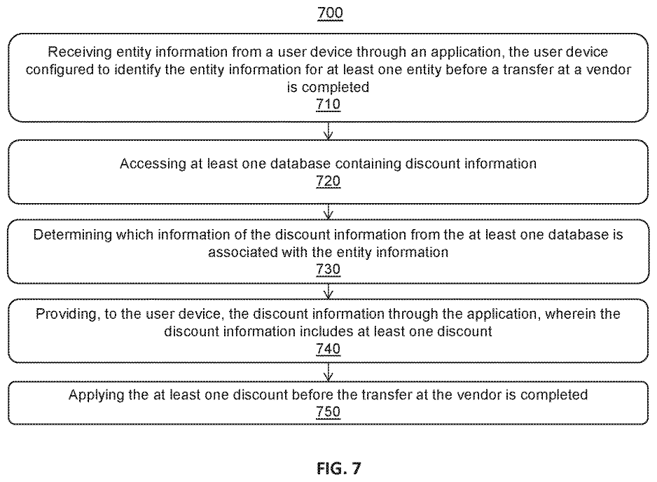

FIG. 7 illustrates an exemplary process 700 for providing a discount, consistent with the disclosed embodiments. Method 700 may be implemented using any embodiments of the present disclosure or the system environments as described herein, represented by FIGS. 3-5B. Method 700 provides an illustration of how various sources of information may be used identify a relevant discount automatically and provide the discount before a transaction occurs. Such a process may provide time-saving benefits to a shopper or to a vendor during the checkout process.

In step 710, process 700 may include receiving entity information from a user device through an application. The user device may be configured to identify the entity information for at least one entity before a transfer at a vendor is completed. Identifying entity information may include using a detector (e.g. smartphone camera or barcode scanner) to obtain an image. The image may be digitized and uploaded to the discount application. The discount application, user device, API, or server may perform image processing on the image, as described above. The application may prompt the user to verify whether the entity matches the entity information. For example, this entity match may occur before or during upload of the entity information to the server. For example, the entity information may be product information as described previously. Entity information may be received from a user device through an application. The user device may be configured to identify entity information for at least one entity before a transfer at a vendor is completed. For example, an entity may be a product sold by a vendor. For example, the transfer may be a vendor transaction. The user device may include a smartphone operating a discount application that can communicate with a server through an API. The user device may engage with a user through an application (e.g., discount application) running on the user device. The user device may identify entity information that corresponds with at least one entity available for purchase at a vendor.

Process 700 may include step 720 of accessing at least one database containing discount information. The at least one database may also store user information or vendor information which may aid in identification and use of the discount information. User information may include any information related to the user and provided from the user device. Vendor information may include any information related to the vendor that is received by the server and stored in the database. Discount information may include any information related to at least one discounts for at least one entity available for purchase at least one vendor.

Process 700 may include step 730 of determining which information of the discount information from the at least one database is associated with the entity information. Determining the information association may include various analyses assessing the content of the information to determine whether the content matches information related to an entity. For example, an image may be taken of the entity by a user device, the image uploaded to the server, and the server may employ a trained machine learning model to assess the content of the image and find associated features and information in the database.

Process 700 may include step 740 of providing, to the user device, discount information through the application. The discount information may include at least one discount. Step 740 may include providing at least one discount to at least one entity in real-time before a transfer is completed. When the server identifies discount information related to the entity information, the server may send the information through an API and user device to the discount application. The discount application may display the discount information to the user on a GUI on a user device for selection as at least one discount to be used for at least one entity. The discount information may be provided while a user is shopping, or during checkout.

Process 700 may include step 750 of applying the at least one discount before the transfer at the vendor is completed. Applying the discount may occur through the user device in communication with a checkout device. For example, a QR code or an alphanumeric code may be used to transfer information between the devices.

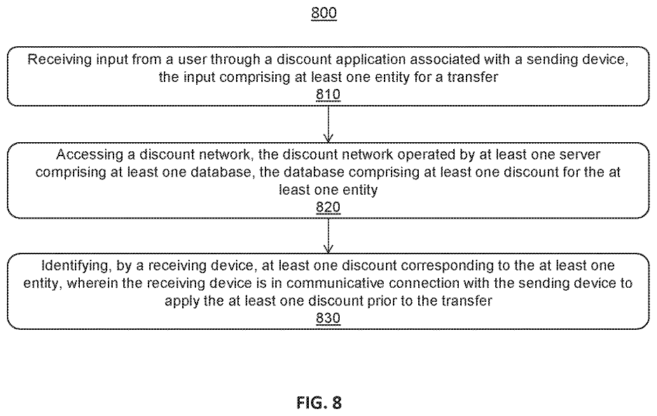

FIG. 8 illustrates example process 800 for obtaining discount information, consistent with the disclosed embodiments. Process 800 may be implemented using any system environment described previously or illustrated in FIGS. 3-5B. Process 800 may involve use of a sending device, discount network, and receiving device to obtain at least one discount for at least one entity (e.g. product). Process 800 may include receiving input from a user. The input may comprise at least one product for purchase at a vendor. The application may communicate through a discount network that stores information related to discounts and entities. A discount corresponding to an entity may be identified by the discount network. The receiving device may communicate with the sending device to apply the at least one discount prior to the purchase.

Process 800 may include step 810 of receiving input from a user through a discount application associated with a sending device. The input may include at least one entity for a transfer. The sending device may be different from a user device, or the sending device may be the same as the user device 210. The user device may be a smartphone. The discount application may allow user input through a GUI. User input may include text, voice, numbers, selection of checkboxes or buttons, etc. The input may comprise product information for at least one product for a purchase at a vendor. As discussed previously, product information may be information that describes or characterizes a product.

Process 800 may include step 820 of accessing a discount network operated by at least one server comprising at least one database. The database may include at least one discount for the at least one entity. The discount network may store and allow access to discounts. The discount network may also allow for searching of discounts. At least one database associated with the at least one server may store user information, vendor information, or discount information, as described previously.

Process 800 may include step 830 of identifying, by a receiving device, at least one discount corresponding to the at least one entity. The receiving device may be in communicative connection with the sending device to apply the at least one discount prior to the transfer. The receiving device may be a server. The receiving device may communicate with the sending device to apply at least one discount to at least one product prior to a vendor transaction. Communicative connection may include any wired or wireless connection through a network. For example, the receiving device may be operated by a bank (i.e. financial institution) or another entity. The receiving device may be operated by the same bank or entity as the discount network.

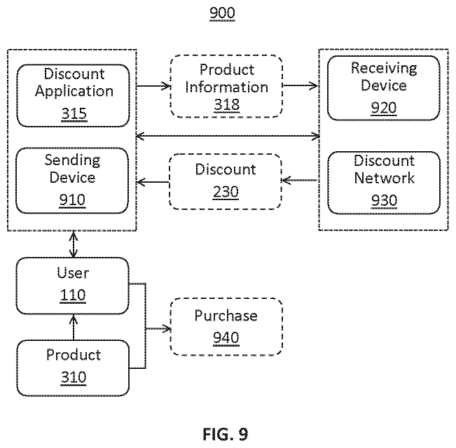

FIG. 9 illustrates an example system environment 900 for exchanging information between sending device 910 and receiving device 920 for purchase 940 using discount 230. Sending device 910 may include user device 210. Receiving device 920 may include server 330. Discount network 930 may include database 360. Discount network 930 may store and provide discount 230 or discount information 370. In some embodiments, sending device 910 and receiving device 920 may communicate directly to exchange various information. In some embodiments, the exchange of various information may occur through API 320. Various information may include product information 318 and discount 230, and general information related to communication between sending device 910 and receiving device 920. Receiving device 920 may send discount information 370, as described previously. Sending device 910 may send user information 416 to receiving device 920, as described previously. Discount application may use GUI 510 to interface with user 110. Discount application may display discount 230 for product 310, and user 110 may select discount 230 to apply during purchase 940 of product 310. Purchase 940 may include vendor transaction 312 at vendor 120.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1-35. (canceled)

36. A system comprising:
a sending device configured to, prior to completion of a point-of-sale transaction, generate product information identifying a product at a vendor, wherein the product information is derived from a scan of the product;
a discount network operated by at least one server comprising at least one database storing discount records in a data structure indexed by a plurality of product identifiers; and
a receiving device configured to:
receive the product identifier from the sending device prior to authorization of the point-of-sale transaction;
query the discount network using the product identifier to identify a discount record associated with the product and the vendor; and
control authorization of the point-of-sale transaction such that the identified discount record is applied to the point-of-sale transaction before completion.

37. (canceled)

38. (canceled)

39. (canceled)

40. (canceled)

41. (canceled)

42. The system of claim 36, wherein the scan includes at least one image obtained using a camera of the sending device.

43. The system of claim 42, wherein the product information includes a representation of the at least one image, the representation obtained using image processing or image compression.

44. The system of claim 42, wherein the at least one image includes an image of the product captured at a point-of-sale.

45. The system of claim 44, wherein the at least one image includes an identification of the product, the identification including one or more of an alphanumeric code, a barcode, a QR code, a text description, and a brand name.

46. (canceled)

47. (canceled)

48. (canceled)

49. The system of claim 1, wherein the product information is obtained using at least one neural network.

50. The system of claim 49, wherein the at least one neural network is trained using feedback from the sending device, wherein the sending device is configured to allow a user operating the user device to select a match of the at least one product and the product information.

51. The system of claim 49, wherein the at least one neural network is trained using feedback from the sending device, wherein the sending device is configured to allow a user operating the user device to deselect a match of the at least one product and the product information.

52. The system of claim 36, wherein the sending device is configured to provide geolocation information to the receiving device to identify discounts from the discount network relevant to a geolocation of a physical store in which the sending device is located.

53. (canceled)

54. The system of claim 52, wherein the discounts relevant to the location of the physical store are provided to the sending device automatically via a notification.

55. The system of claim 36, wherein the discount network is maintained by a third-party entity separate from the receiving device and the sending device.

56. The system of claim 36, wherein the identified discount record includes a barcode to be scanned during the transfer.

57. The system of claim 36, wherein the identified discount record includes a discount code to be input during the transfer.

58. The system of claim 36, wherein the identified discount record is configured to be determined using at least one discount information neural network trained using feedback from a plurality of users interacting with a plurality of sending devices.

59. The system of claim 58, wherein the at least one discount information neural network is further trained by monitoring activity associated with the discount network, the transfer, and the plurality of users.

60. The system of claim 36, wherein the receiving device further comprises a database configured to store transaction information associated with user information, the product information, and the discount network.

61. The system of claim 60, wherein the receiving device is configured to allow a user to access and modify the transaction information.

62. The system of claim 36, wherein the sending device is configured to allow a user to select a plurality of discounts for product and apply the plurality of discounts during the point-of-sale transaction.

63. The system of claim 36, wherein the identified discount record includes one discount applied to a plurality of entities simultaneously.

64. The system of claim 36, wherein the identified discount record includes information about a plurality of users using the at least one discount.

65. The system of claim 36, wherein if no discount is found, the discount network indicates to a user via the user device that no discount was found.

66. The system of claim 36, wherein the identified discount record is scored based on a success metric, wherein the success metric is based on the probability that a vendor will accept the identified discount record.

67. The system of claim 36, wherein if no matching discount is found, a potential discount is provided in the identified discount record.

68. The system of claim 67, wherein the potential discount is scored with a success metric, wherein the success metric is based on the probability that a vendor will accept the potential discount.

69. A method comprising:
generating, prior to completion of a point-of-sale transaction, by a sending device, product information identifying a product at a vendor, wherein the product information is derived from a scan of the product;
accessing a discount network operated by at least one server comprising at least one database storing discount records in a data structure indexed by a plurality of product identifiers; and
receiving, by a receiving device, the product identifier from the sending device prior to authorization of the point-of-sale transaction;
querying, by the receiving device, the discount network using the product identifier to identify a discount record associated with the product and the vendor; and
controlling, by the receiving device, authorization of the point-of-sale transaction such that the identified discount record is applied to the point-of-sale transaction before completion.
